(19) United States
(12) Patent Application Publication
(10) Pub. No.: US 2025/0370993 A1
(43) Pub. Date: Dec. 4, 2025

(54) QUERY ROUTING FOR GENERATING ACCURATE DATA REPORTS USING MULTIPLE DATA SOURCES

(71) Applicant: Google LLC, Mountain View, CA (US)

(72) Inventors: Chen Luo, Irvine, CA (US); Xiaoli Chen, Irvine, CA (US); Jian Zhang, Palo Alto, CA (US); Stefano Menti, San Francisco, CA (US); Manish Agrawal, Sunnyvale, CA (US); Rachit Daga, Sunnyvale, CA (US)

(73) Assignee: Google LLC, Mountain View, CA (US)

(21) Appl. No.: 18/680,229

(22) Filed: May 31, 2024

(51) Int. Cl. G06F 16/242; G06F 11/34; G06F 16/2458

(52) U.S. Cl. CPC G06F 16/2425; G06F 11/3409; G06F 16/2471

(57) ABSTRACT

Methods, systems, and apparatus, including computer programs encoded on a computer storage medium, for selecting a most accurate data source to be used to respond to a query and responding with a result using data from the selected data source. In one aspect, a method includes receiving, from a user, an input query related to user interactions with a platform for one or more users of the platform. The input query is processed to select a data source to be used for responding to the input query. The output includes a likelihood that a first result corresponding to the input query obtained using a first data source has a higher accuracy than each of one or more second results corresponding to the input query obtained using one or more second data sources. A result corresponding to the input query is obtained using the selected data source and the result is provided.

### BACKGROUND

This specification relates to data processing and selecting a data source to be used to respond to a query.

In many situations, large amounts of data are collected and stored for the purposes of generating summaries of the data, metrics, user interfaces, etc. However, processing such data in response to queries can involve significant computing resources and/or latency.

### SUMMARY

In general, one innovative aspect of the subject matter described in this specification can be embodied in methods that include the actions of receiving, from a user, an input query related to user interactions with a platform for one or more users of the platform; processing the input query to select a data source to be used for responding to the input query by obtaining an output from a model that includes a likelihood that a first result corresponding to the input query obtained using a first data source has a higher accuracy than each of one or more second results corresponding to the input query obtained using one or more second data sources, wherein a plurality of data sources for the platform comprise the first data source and the one or more second data sources, and wherein the selected data source is one of the plurality of data sources for the platform, and wherein the plurality of data sources comprise at least an event data source and an aggregated data source; obtaining a result corresponding to the input query using the selected data source; and providing the result to the user. Other implementations of this aspect include corresponding apparatus, systems, and computer programs, configured to perform the aspects of the methods, encoded on computer storage devices.

These and other embodiments can each optionally include one or more of the following features.

The input query can specify one or more of: a type of interaction event for the user interactions, a time period for the user interactions, a geographic location for the user interactions, a count of the user interactions, or a frequency of the user interactions.

The event data source can include, for each interaction event of a plurality of interaction events, one or more features and corresponding feature values for the respective interaction event. In some implementations, the one or more features can include any one or more of: a geographic location for the respective interaction event, a time of the respective interaction event, a description of the respective interaction event, or an identifier for the respective interaction event.

The aggregated data source can include a plurality of aggregated results, wherein each of the aggregated results corresponds to a potential input query. In some implementations, at least one of the aggregated results can be generated by aggregating corresponding feature values for two or more interaction events over at least one feature.

Processing the input query to select a data source to be used for responding to the input query can include: determining whether a sampling ratio for the event data source meets a threshold sampling ratio; in response to determining that the sampling ratio for the event data source meets the threshold sampling ratio, providing a model input comprising at least two or more characteristics of the plurality of data sources to the model to obtain the output from the model; and selecting the data source to be used for responding to the input query based on the output from the model. In some implementations, determining whether a sampling ratio for the event data source meets a threshold sampling ratio can include: determining whether a data loss percentage for the aggregated data source meets a threshold data loss percentage; in response to determining that the data loss percentage for the aggregated data source meets a threshold data loss percentage, determining whether the event data source is eligible to be used to compute a result corresponding to the input query; and in response to determining that the event data source is eligible to be used to compute a result corresponding to the input query, determining whether a sampling ratio for the event data source meets a threshold sampling ratio. In some implementations, selecting the data source to be used for responding to the input query based on the output from the model can include determining that the likelihood meets a threshold likelihood; and in response, selecting the first data source to be used for responding to the input query.

The first data source can be the event data source and the one or more second data sources can include the aggregated data source. In some implementations, the two or more characteristics of the plurality of data sources can include a sampling ratio for the event data source and a data loss percentage for the aggregated data source. In some implementations, the model can include, for each combination of characteristic values for the two or more characteristics, a respective probability representing the likelihood that a first result corresponding to the input query obtained using the event data source has a higher accuracy than a second result corresponding to the input query obtained using the aggregated data source.

The model input further can include any one or more of: one or more features of the input query, or one or more characteristics of the platform. In some implementations, the model can have been trained to output a likelihood that a first result corresponding to the input query obtained using the first data source has a higher accuracy than each of one or more second results corresponding to the input query obtained using one or more second data sources. In some implementations, the model can be a trained classifier that has been trained on training data comprising a plurality of training examples, each comprising at least a model input, and a ground-truth label identifying one of the plurality of data sources, wherein a first measured result corresponding to the input query obtained using the identified data source has a higher accuracy relative to one or more second measured results.

Obtaining a result corresponding to the input query using the selected data source can include obtaining a query from the input query; and querying the selected data source using the query.

The plurality of data sources for the platform can include data related to user interactions with the platform for a window of time.

Particular embodiments of the subject matter described in this specification can be implemented so as to realize one or more of the following advantages. The techniques described in this specification enable more accurate results when responding to an input query by selecting a best (e.g., more accurate) data source based on the input query and/or the data stored by each data source. The system can select a data source for a platform for which a result obtained using the data source has a higher likelihood of being accurate compared to results obtained using other data sources for the platform. For example, the system can process the input query to select a data source by providing a model input to a model, e.g., a data processing model or a machine learning model, that is configured to output a likelihood that a result obtained using a data source has a higher accuracy than results obtained using one or more other data sources. Thus, the techniques described in this specification enable the generation of and provision of higher quality data reports with the results.

The techniques described in this specification also reduce latency in providing results in response to an input query, e.g., by meeting a latency requirement that defines a maximum time period in which a result must or at least should be provided in response to an input query. For example, the data sources can include an aggregated data source and an event data source. The aggregated data source includes aggregated results that can be queried quickly to compute a result. However, the aggregated results can be inaccurate due to a cardinality limitation. For example, the aggregated data source can store a limited number of aggregated results. For platforms with a large number of interaction events, some of the interaction events may be aggregated into an “other” feature value, leading to information loss about those interaction events due to aggregation. The event data source includes information about interaction events over a period of time. However as the number of events for which data is stored in the event data source becomes very large, e.g., in the billions or trillions per day, querying the event data source can take longer and, in some examples, will not meet the latency requirement. Thus, the system can sample from the event data source, that is, query from a subset of interaction events. However, if the system samples a lower percentage of the interaction events, the accuracy of the result can decrease. Thus, by selecting a data source based on the output from a model that indicates a likelihood that a result obtained using the event data source has a higher accuracy than a result obtained using the aggregated data source, the system can balance speed and accuracy, thereby providing the most accurate results possible within a defined time period (e.g., based on a latency requirement of the system).

The system described in this specification is also flexible. For example, if the system determines that there is little or no information lost for the aggregated results, the system can select the aggregated data source.

The techniques provide for a convenient and efficient user experience. For example, the system receives an input query from a user associated with the platform. The system automatically selects a most accurate data source to be used to respond to the query, and provides a result corresponding to the input query using the selected data source.

The techniques described in this specification provide for accurate results while also taking latency into account. The techniques get the user to the information that the user is seeking more quickly, which results in fewer input queries by the user, fewer queries to the data sources run by the system, and reduces the number of user interfaces (e.g., web pages) and/or other resources to which the user has to navigate to find relevant information. All of these things reduce computation burden placed on computing resources to transmit the input queries and perform queries using data sources, which also reduces the amount of consumed bandwidth of the network and battery power of client devices of users submitting the input queries. This also reduces the number of inputs that need to be provided by a user, resulting in less time that the display of client devices are illuminated, which provides additional battery savings.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating interactions between a data management system and a client device.

FIG. 2 is a diagram illustrating an example process for selecting a data source for an input query.

FIG. 3 is a diagram illustrating an example process for generating a grid model or training a model for selecting a data source.

FIG. 4 depicts a visualization of an example model for selecting a data source.

FIG. 5 is a flow chart of an example process for training a model for selecting a data source.

FIG. 6 is a flow chart of an example process for obtaining a result for an input query using a selected data source.

FIG. 7 is a block diagram of an example computer.

Like reference numbers and designations in the various drawings indicate like elements.

### DETAILED DESCRIPTION

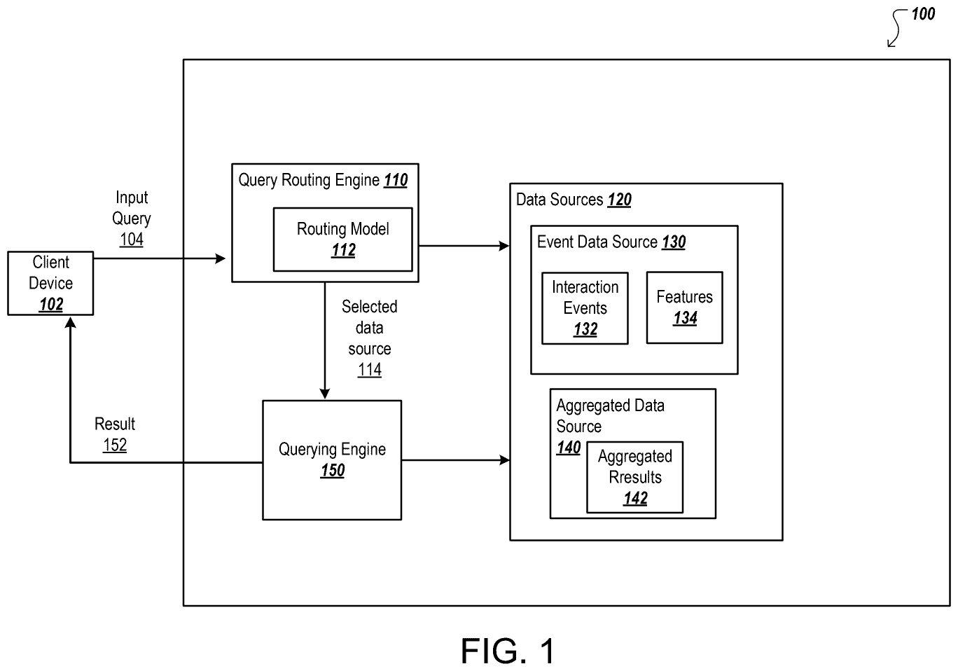

FIG. 1 is a block diagram illustrating interactions between a data management system 100 and a client device 102. The data management system 100 includes a query routing engine 110, multiple data sources 120, and a querying engine 150.

Although FIG. 1 shows two data sources for a platform, an event data source 130 and an aggregated data source 140, the system 100 can include more than two data sources. For example, the data sources 120 can include multiple data sources for multiple different platforms. Each platform can allow users of the platform to interact with content of the platform, e.g., media content, services, games, etc., through applications or websites provided by the platform on user devices. The data sources 120 can include an aggregated data source and an event data source for each of the multiple platforms.

In another example, the multiple data sources 120 can include multiple data sources for each of one or more entities. For example, the data management system 100 can store data for multiple entities and allow those entities to query their data in various forms, e.g., to query metrics that are determined based on the stored data. In a particular example, the data management system 100 can include an event data source 130 and an aggregated data source 140 for each entity.

A user of the client device 102 can interact with the system 100 through a user interface of the client device 102. For example, the user interface can be displayed on the client device 102. The user can interact with contents of the user interface by speaking, typing, or using a pointer, for example. The user of the client device 102 can be associated with a particular platform.

The user interface can be configured to allow a user to provide input queries such as the input query 104. For example, the user interface can allow a user to type an input query or select text to include in the input query. The user interface can also display results such as a result 152 that corresponds to the input query 104. A result can include, for example, text and/or visualizations that are responsive to the input query.

The user interface displayed at the client device 102 can be updated by the system 100. For example, the system 100 can provide data representing the result 152 for display by the user interface. The system 100 can thus update the user interface to provide the result to the user.

In some implementations, the data stored and managed by the data management system 100 can be related to events. This enables entities to query data related to the events and/or metrics related to the events. For example, the events can be user interactions with a platform or content displayed by web pages, applications, platforms, and/or other types of user interactions. The user interactions can include, for example, viewing content (e.g., when the content is displayed to a user), selecting content, hovering over content (e.g., using a mouse or pointer), performing a specified conversion event after interacting with content, making a purchase from a platform, accessing an application for a platform, performing an action in a game, leveling up in the game, and/or other types of user interactions. Although the following description is largely in terms of user interaction events, the systems and techniques described in this document can apply to other types of events and more generally to other types of data.

Content can include, for example, an interactive element such as a button or a link to an electronic document, and/or a digital component. As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The input query 104 can be related to the type of event data stored by the data management system 100. For example, the input query 104 can be related to user interactions with a platform for one or more users of the platform and/or for user interactions with content displayed by a platform, web page, or other type of user interface. In a particular example, the input query 104 can specify types of interactions for which data should be returned.

In some examples, the input query 104 can include a natural language statement. In some examples, the input query 104 can have a predefined format. For example, the user interface can allow the user to select or insert options from one or more predefined lists to generate an input query in the predefined format.

The input query 104 can include one or more features related to user interactions. For example, the input query 104 can specify a type of interaction event for the user interactions.

The input query 104 can specify a time period for the user interactions. For example, the time period can include a particular date, a particular time, or a date range or time range. As an example, the time period can be a window of time prior to the date or time the system 100 received the input query 104. For example, the time period can include the past 30 days from the date the system 100 received the input query 104.

The input query 104 can specify a geographic location for the user interactions. That is, the input query 104 can specify a geographic location, e.g., by state, country, or region, of the user device when the user interaction occurred. For example, the geographic location can include one or more countries or regions.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that no personally identifiable information can be determined for the user, or a user's geographic location may be generalized where location information is obtained (such as to a city, ZIP code, or state level), so that a particular location of a user cannot be determined.

The input query 104 can specify a count of the user interactions. For example, the count of the user interactions can include a total number of user interactions across users, or per user.

The input query 104 can specify a frequency of the user interactions. For example, the frequency of the user interactions can include a number of user interactions over a period of time. As a particular example, the frequency can include a number of user interactions per day.

In some examples, the input query 104 can specify a combination of features, e.g., of a type of interaction event for the user interactions, a time period for the user interactions, a geographic location for the user interactions, a count of the user interactions, and/or a frequency of the user interactions. Each of these can be considered a feature of the input query 104. For example, the input query 104 can specify a number of selections per day in the past 30 days. As another example, the input query 104 can specify a number of users who have hovered over a digital component per day in the past 30 days. As another example, the input query 104 can specify a number of active users of a platform in the USA for a particular date.

In some examples, the input query 104 can specify other features related to user interactions, such as a duration of a user interaction, revenue for a platform, an identifier for a particular interactive element, and/or information about the user device or application on which the user interaction occurred.

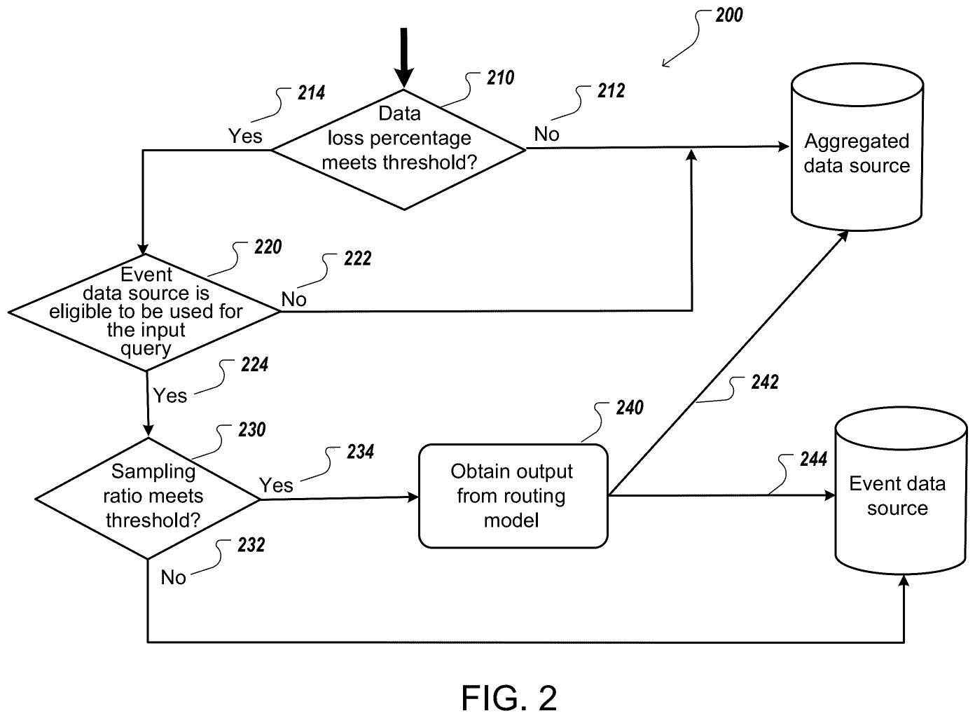

The system 100 provides the input query 104 to the query routing engine 110. The query routing engine 110 processes the input query 104 to select a data source for use in obtaining data to provide as a result 152 or data to use in generating the result 152. An example process for selecting a data source for an input query 104 is described below with reference to FIG. 2.

In some examples, the query routing engine 110 processes the input query 104 to identify one or more features related to user interactions that are included in the input query 104. For example, if the input query 104 is a natural language query, the query routing engine 110 can use a language model neural network to identify the one or more features. If the input query 104 is in a predefined format, the query routing engine 110 can extract the one or more features according to the predefined format, e.g., using rules, code, or other appropriate mechanisms.

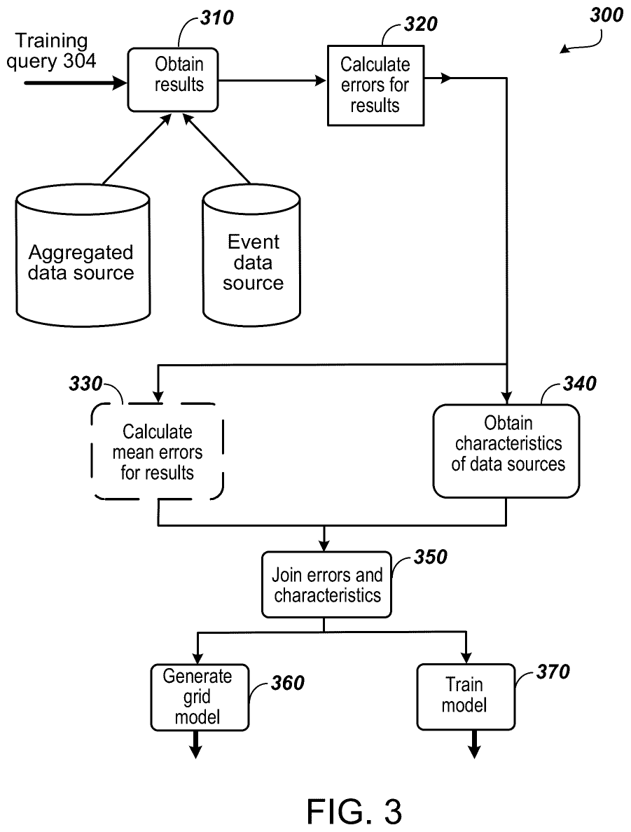

In some examples, the query routing engine 110 uses a routing model 112 to select a data source of the data sources 120. The query routing engine 110 selects a data source of the data sources 120 to be used for responding to the input query 104 by obtaining an output from the routing model 112. The output includes a likelihood that a result corresponding to the input query 104 obtained using a particular data source of the data sources 120 has a higher accuracy than each of one or more other results obtained using other data sources of the data sources 120. To obtain an output from the routing model 112, the query routing engine 110 provides a model input to the routing model 112. The model input includes at least two or more characteristics of the data sources 120 for the platform. Example routing models are described below with reference to FIGS. 3-5.

In the example of FIG. 2, the data sources 120 for the platform include the event data source 130 and the aggregated data source 140. In this example, the data sources 130 and 140 store data about user interactions, although other types of data can be stored as described above.

The event data source 130 includes information about multiple interaction events 132. For example, for each interaction event of the interaction events 132, the event data source 130 can include one or more features 134 and corresponding feature values. The event data source 130 can store any data that can be sampled, and interaction events 132 are an example of such data.

In some examples, a result can include one or more subresults. As an example, the query can be a query for active user count by country for the previous day. The result for the query can include active user count for the previous day in different countries. Each subresult for the result can include active user count for the previous day for a particular country. For example, a subresult for the result can include active user count for the previous day in a particular country, such as in the USA. Thus, in some examples, obtaining a result using the event data source 130 can include sampling the event data source 130 for the one or more subresults. For example, the system 100 can use the query engine 150 described below to query the event data source 130 to obtain each sampled subresult.

Each interaction event of the interaction events 132 can represent a user interaction with the platform or content. The features 134 can include, for each of the interaction events 132, a type of the interaction event (e.g., opening an application, making a purchase through the application, selecting content, hovering over content, etc.), a geographic location for the interaction event (e.g., a country or a region), a time of the interaction event (e.g., a timestamp for the interaction event), a description of the interaction event, an identifier for a user device or user account for the interaction event, and/or an identifier for the interaction event. In some examples, the features can include other features related to user interactions, such as a duration of a user interaction, revenue for the platform, an identifier for a particular interactive element, and/or information about the user device or application on which the interaction event occurred.

The event data source 130 includes corresponding feature values for each of the features. For example, for a particular interaction event, the event data source 130 can include 12:30:21 pm PST as the corresponding feature value for the time feature.

The aggregated data source 140 includes aggregated results 142. In some examples, each of the aggregated results 142 corresponds to a potential input query that can be received by the system 100. That is, each of the aggregated results can be used to obtain the result 152. Each potential input query can identify a combination of features.

In some examples, an aggregated result can include one or more aggregated subresults. As an example, the query can be a query for active user count by country for the previous day. The result for the query can include active user count for the previous day in different countries. Each aggregated subresult for the result can include active user count for the previous day for a particular country. For example, an aggregated subresult for the aggregated result can include active user count for the previous day in a particular country, such as in the USA.

The aggregated data source 140 can include aggregated results 142 over combinations of features. For example, a combination of features can include active user count by date. The aggregated data source 140 can store aggregated results for multiple combinations of features in an aggregated table. In some examples, the aggregated data source 140 can include aggregated results for a superset of possible combinations of features. For example, an aggregated data source can include the active user count per date for the last seven dates. The aggregated data source can also include the active user count per date and per country for the last seven dates and, for example, ten countries.

In some examples, the system 100 can generate the aggregated results 142 using the event data source 130. For example, the system 100 can generate an aggregated result by aggregating corresponding feature values for two or more interaction events of the event data source 130 over at least one feature. An aggregated result can include, for example, a count, a unique count, a sum, an average, other measure of central tendency, etc.

As an example, the aggregated results 142 can include aggregated results for active user count for a platform by date. The system 100 can generate an aggregate result over the type of interaction event and the time of the interaction event. For example, for each date of one or more dates, the system 100 can identify interaction events that have feature values for the time feature that fall on the date. For each date, the system 100 can generate the aggregate result by generating a count of the unique user accounts of the identified interaction events.

As another example, the aggregated results 142 can include aggregated results for active user count by date and country. The system 100 can generate an aggregate result over the type of interaction event, time of the interaction event, and geographic location of the interaction event. For example, for each date of one or more dates, the system 100 can identify interaction events that have feature values for the time feature that fall on the date. For each country of one or more countries, the system 100 can identify interaction events that have feature values for the location feature that occurred in the country. For each date and country, the system can generate the aggregate result by generating a count of the unique user accounts of the identified interaction events that occurred on the date and in the country.

As another example, the aggregated results 142 can include aggregated results for average number of clicks per day. The system 100 can generate an aggregate result over the type of interaction event, and time of the interaction event. For example, for each of one or more dates, the system 100 can identify interaction events that have feature values for the type of interaction event that indicates a “click.” For each of the one or more dates, the system can generate a number of clicks per day by generating a count of the number of identified interaction events for the date. The system can generate the aggregated result by computing the average number of clicks per day, e.g., by summing the number of clicks per day for each of the dates and dividing by the number of dates.

In some examples, the aggregated results 142 can include aggregated results that are combined for different feature values of the same feature. For example, for features that have a large number of unique feature values, the aggregated results 142 can represent interaction events with different feature values for the same feature into an “other” feature value. As an example, for aggregated results for number of active users by country, the system can determine the active users for individual countries, and/or for multiple countries. For example, the aggregated result for active users for multiple countries includes a sum of the number of active users for the multiple countries. As an example, the aggregated results 142 can store the aggregated result for remaining countries under the feature value “other.”

In some examples, the system can generate the aggregated results 142 using data sources other than the event data source 130. For example, the system can generate the aggregated results 142 using other historical data sources.

The system 100 can have generated the aggregated results 142 prior to the system 100 receiving the input query 104, such that the aggregated results 142 can be provided in response to an input query 104 without the delay of aggregation at query time. For example, the system 100 can generate the aggregated results 142 on a regular basis, e.g., periodically based on a defined time period. As an example, the system can generate the aggregated results 142 weekly or daily. Thus, although the aggregated results 142 are generated prior to the system 100 receiving the input query 104, the aggregated results 142 can reflect updated information.

The system 100 obtains a result 152 corresponding to the input query 104 using the data source selected by the query routing engine 110. The system 100 provides data representing the selected data source 114 to the querying engine 150. The querying engine 150 is configured to query the selected data source. In some examples, the query engine 150 generates a database query for the input query 104 for the selected data source.

For example, if the input query 104 includes active user count per day over the last seven days, the query engine 150 can generate a different database query depending on the selected data source. For example, if the event data source 130 is the selected data source, the query engine 150 can sample, or randomly select, a subset of the interaction events to query from. The subset can include up to a sampling limit of interaction events. The database query can include a request to identify a number of active users per day over the last seven days by identifying from the subset, for each of the last seven days, a number of unique users with interaction events.

If the aggregated data source 140 is the selected data source, the query engine 150 can query the aggregated data source 140. For example, the database query for the aggregated data source 140 can include a request for the number of active users per day over the last seven days.

The system 100 provides the result 152 to the client device 102, e.g., by updating the user interface to display data representing the result 152. In some examples, the system 100 can further process the result 152 to generate data representing the result 152. For example, the system 100 can perform further aggregation, e.g., averaging, of the result 152. As another example, the system 100 can generate visualizations of the result 152 such as tables and/or charts that display the result 152.

FIG. 2 is a diagram illustrating an example process 200 for selecting a data source for an input query. Operations of the process 200 can be performed, for example, by the system 100 described with reference to FIG. 1. In particular, operations of the process 200 can be performed by the query routing engine 110 of FIG. 1, or another data processing apparatus.

In this example, the system can use a data loss percentage for the aggregated data source and/or a sampling ratio for the event data source to select a data source, or to determine whether to use a routing model to select the data source. For example, the system can determine that a data loss percentage for the aggregated data source is less than a threshold data loss percentage. If so, the system can select the aggregated data source. If not, the system can determine whether the event data source is eligible to be used for the input query. If not, the system can select the aggregated data source. If so, the system can use the routing model 112 to select the data source based on a likelihood that either data source provides a more accurate result than the other data source(s) for an input query. That is, the system can use the routing model 112 to select either the event data source or the aggregated source based on a likelihood that either data source provides a more accurate result than the other data source.

The system receives the input query 104 as described above with reference to FIG. 1.

The system determines whether a data loss percentage for the aggregated data source

meets a threshold data loss percentage (210). The data loss percentage for the aggregated data source is a measure of how much information is lost due to aggregation. For example, the data loss percentage is the ratio of the number of events in the “other” feature value row over the total number of events represented in the aggregated data source. As an example, if the aggregated results include a result for the “other” feature value, the data loss percentage is the number of events represented in “other,” divided by the total number of events represented in the aggregated data source.

The threshold data loss percentage can be a predefined percentage, e.g., 0%, 10%, 15%, or another appropriate value depending on the application. The system can determine that the data loss percentage meets the threshold data loss percentage if the data loss percentage is greater than or equal to the threshold data loss percentage. The system can obtain the data loss percentage using the metadata of the aggregated data source. As an example, the system can generate the data loss percentage for the aggregated data source when generating the aggregated results.

In response to determining that the data loss percentage does not meet the threshold data loss percentage (212), the system selects the aggregated data source to be used for responding to the input query 104. That is, because less than the threshold amount of information is lost due to aggregation, the system selects the aggregated data source. Obtaining a result from the aggregated data source requires less computing time and resources than obtaining a result from the event data source.

In response to determining that the data loss percentage meets the threshold data loss percentage (214), the system determines whether the event data source is eligible to be used for the input query (220). For example, the system can determine whether the event data source includes one or more features and corresponding feature values that can be used to compute a result corresponding to the input query 104.

In response to determining that the event data source cannot be used for the input query (222), the system selects the aggregated data source to be used for responding to the input query 104.

For example, the system can determine whether the event data source includes one or more features and corresponding feature values that can be used to compute a result corresponding to the input query 104. As an example, some of the aggregated results of the aggregated data source can have been generated from data not found in the event data source. Thus, in some examples, the event data source does not include features and corresponding feature values that can be used to compute the result corresponding to the input query 104. The system can thus determine that the event data source cannot be used for responding to the input query 104.

As another example, obtaining a result corresponding to the input query 104 may require information that is not stored in the event data source. In some examples, the event data source stores information about interaction events over a certain time period, e.g., 60 days. The input query 104 may include active users over the last year. Because the event data source does not include enough information for the input query 104, the system can determine that the event data source cannot be used for responding to the input query 104.

In response to determining that the event data source can be used for the input query (224), the system determines whether a sampling ratio for the event data source meets a threshold sampling ratio (230). The sampling ratio for the event data source is a measure of how many interaction events would be considered in computing the result relative to the total number of interaction events due to sampling. As an example, if the event data source includes information for 100 million interaction events, and the system would query 10 million interaction events for the platform, the sampling ratio is 10%. As another example, if the event data source includes 500,000 interaction events, and the system would query up to one million interaction events for the platform, the system can query all of the interaction events, and the sampling ratio is 100%. Sampling, that is, selecting a subset of interaction events for querying, allows the system to respond to queries within a certain amount of time even when the number of interaction events to query is extremely large.

The threshold sampling ratio can be a predefined ratio, e.g., 80%, 90%, 100%, or another appropriate value based on the application. The system can determine that the sampling ratio meets the threshold sampling ratio if the sampling ratio is less than the threshold sampling ratio. The system can obtain the sampling ratio using the total number of interaction events in the event data source and a sampling limit. In some examples, the sampling limit is specific to the platform for the user from which the input query 104 is received. For example, the sampling limit for a first platform can be 10,000 events, and the sampling limit for a second platform can be one million events. In some examples, the system determines the sampling limit based on a latency requirement. For example, the system can determine that the sampling limit for a platform can be 500,000 events in order to satisfy a latency requirement of one second for obtaining the result to the input query 104.

In response to determining that the sampling ratio does not meet the threshold sampling ratio (232), the system selects the aggregated data source to be used for responding to the input query 104.

In response to determining that the sampling ratio meets the threshold sampling ratio (234), the system obtains an output from the routing model (240). For example, the system can provide a model input that includes at least two or more characteristics of the data sources to the routing model to obtain the output from the routing model. Because obtaining a result corresponding to the input query 104 would require data loss for the aggregated data source and sampling for the event data source, the system can use the routing model to select a data source that is likely to have a higher accuracy. Obtaining a result from the routing model is described in further detail below with reference to FIGS. 3-5.

The system can select the data source to be used for responding to the input query based on the output from the routing model. In some examples, the output includes a likelihood that a result corresponding to the input query 104 obtained using the event data source has a higher accuracy than a result corresponding to the input query 104 obtained using the aggregated data source. In some other examples, the output includes a likelihood that a result corresponding to the input query 104 obtained using the aggregated data source has a higher accuracy than a result corresponding to the input query 104 obtained using the event data source.

If the likelihood that a result corresponding to the input query 104 obtained using the event data source has a higher accuracy than a result corresponding to the input query 104 obtained using the aggregated data source does not meet a threshold likelihood (244), the system can select the aggregated data source to be used for responding to the input query 104.

As an example, the threshold likelihood can be 50%. The system can determine that the likelihood does not meet the threshold likelihood if the likelihood is less than 50%. That is, the system can determine to use the aggregated data source if it is more likely that a result obtained using the aggregated data source is more accurate.

If the likelihood that a result corresponding to the input query 104 obtained using the event data source has a higher accuracy than a result corresponding to the input query 104 obtained using the aggregated data source meets a threshold likelihood (244), the system can select the event data source to be used for responding to the input query 104.

As an example, the threshold likelihood can be 50%. The system can determine that the likelihood meets the threshold likelihood if the likelihood is greater than or equal to 50%. That is, the system can determine to use the event data source if it is more likely that a result obtained using the event data source is more accurate.

FIG. 3 is a diagram illustrating an example process 300 for generating a model for selecting a data source. Operations of the process 300 can be performed, for example, by the system 100 described with reference to FIG. 1 or another system. For example, the system 100 can perform the process 300 to generate the routing model 112 described with reference to FIG. 1. The system can perform the process 300 prior to receiving an input query. In some examples, the system can perform the process 300 multiple times to generate updated models. For example, the system can perform the process 300 at a regular interval of time, e.g., based on a specified time period.

The system receives a training query 304. The training query 304 is similar to the input query 104 described above with reference to FIG. 1.

The system obtains results (310) using the aggregated data source and the event data source. For example, the system can use the querying engine 150 described above with reference to FIG. 1 to obtain one or more queried results corresponding to the training query 304, e.g., an aggregated result using the aggregated data source, and one or more sampled results using the event data source. For example, each of the one or more sampled results can be computed using different sampling ratios, e.g., 0%, 10%, 20%, . . . 90%, 100%. The aggregated result can have been computed using the data loss percentage for the aggregated data source of the platform for the training query 304, e.g., 0%, 10%, 20%, . . . 90%, 100%. For example, for each training query 304, the system can obtain an aggregated result with a data loss percentage based on the platform for the training query 304. The system also obtains an unsampled result using the event data source. For example, the system obtains the unsampled result by querying all of the interaction events of the event data source without sampling.

The system calculates errors for the results (320). For example, the system calculates an error for each of the queried results compared to the unsampled result. That is, the system uses the unsampled result as an actual result. For example, the error can be an absolute percentage error, defined as the absolute value of the difference between the sampled result or the aggregated result and the unsampled result, divided by the unsampled result.

In some examples, the system calculates mean errors for the results (330). For example, some results can include multiple subresults. As an example, the result for a query for active users per country can include twenty subresults, each representing the active user for a different country. Thus the system calculates a mean error for the results by grouping the subresults for each result for the queries. For each group, the system can calculate a mean absolute percentage error (MAPE), which indicates an accuracy of the result.

The MAPE can be determined using Equation 1 below:

$$MAPE = \frac{100 \%}{n} {\sum }_{i = 1}^{n} \vert \frac{{A}_{i} - {Q}_{i}}{{A}_{i}} \vert \qquad Equation 1$$

In Equation 1, n is the number of values in the group, A is the actual subresult, and Q is the queried subresult.

In some examples, the system calculates a log weighted symmetrical absolute percentage error (LWSAPE). The LWSAPE can be determined using Equation 2 below:

$$LWSAPE = avg ( \frac{\vert a - b \vert}{( a + b )} * log ( a ) ) \qquad Equation 2$$

In Equation 2, a is the actual subresult and b is the queried subresult.

The system obtains characteristics of the data sources (340). For example, the system can obtain the data loss percentage for the aggregated data source. For each of the sampled results, the system can obtain the sampling ratio. The system also obtains information about the platform the data sources are associated with, e.g., an identifier or characteristics of the platform.

The system joins the errors (in some examples, the mean errors) and the characteristics (350). For example, the system generates a data item that includes at least an error for a sampled result, an error for an aggregated result, the sampling ratio for the event data source, and the data loss percentage for the aggregated data source.

In some examples, the system can generate a grid model (360). The grid model includes, for each combination of characteristic values for two or more characteristics of the data sources, a probability representing the likelihood that a result corresponding to the input query obtained using one of the data sources has a higher accuracy than a result corresponding to the input query obtained using another data source.

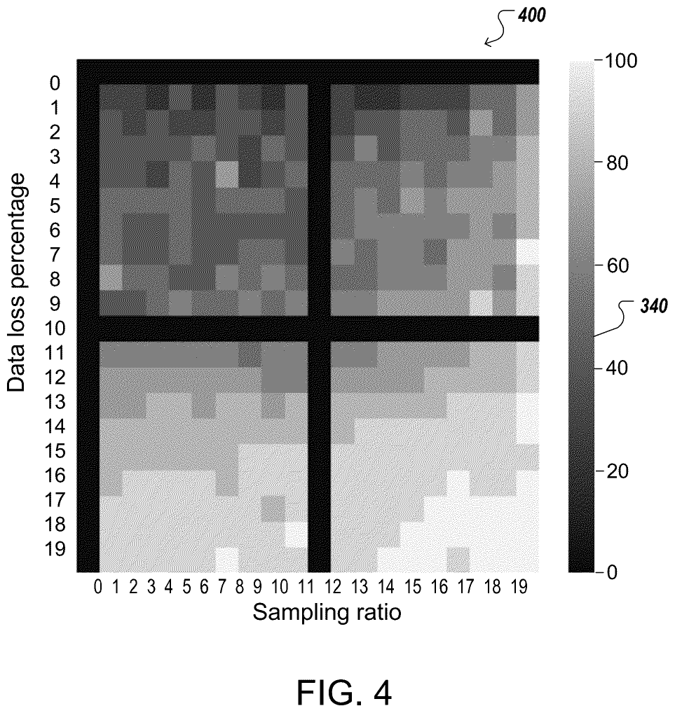

For example, the two or more characteristics of the data sources can include data loss percentage and sampling ratio. For each combination of sampling ratio and data loss percentage, the system can identify the data items that include the sampling ratio and the data loss percentage. For each combination, the system can determine a proportion, e.g., a percentage, of data items for which the sampled result had a lower error. The system can use the percentage for each combination as the likelihood that a result obtained using the event data source has a higher accuracy than a result obtained using the aggregated data source, for example. A visualization of an example grid model is described below with reference to FIG. 4.

In some examples, for each combination, the system can determine a percentage of data items for which the aggregated result had a lower error. The system can use the percentage for each combination as the likelihood that a result obtained using the aggregated data source has a higher accuracy than a result obtained using the event data source, for example.

In some examples, alternatively or in addition to generating a grid model, the system can train a machine learning model (370). For example, the system can generate a training example from each data item. Each training example can include a training model input and a ground-truth label. The ground-truth label that indicates which of the queried results had a lower error. In some examples, a queried result with a lower error has an error that is lower than the error of the other queried result. In some examples, a queried result with a lower error has an error that is lower than the error of the other queried result by at least a predetermined threshold, e.g., 2% or 10% lower.

For example, the system can use “0” to indicate that the sampled result had a lower error, and “1” to indicate that the aggregated result had a lower error. In some examples, the system can use “0” to indicate that the aggregated result had a lower error, and “1” to indicate that the sampled result had a lower error.

The training model input can include two or more characteristics of the data sources, one or more features of the training query 304, and/or one of more characteristics of the platform. For example, the characteristics of the data sources can include the sampling ratio for the event data source, and the data loss percentage for the aggregated data source. For example, features of the training query 304 can include the features identified in the training query 304. For example, characteristics of the platform can include an identifier for the platform and the sampling limit for the platform.

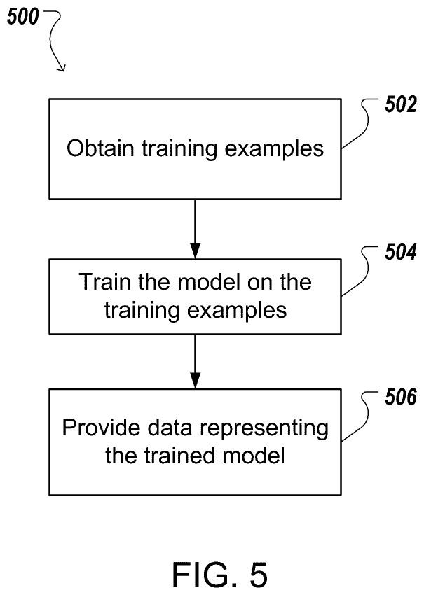

The system can train the machine learning model on the training examples to output a likelihood that a result obtained using the event data source has a higher accuracy than a result obtained using the aggregated data source, for example. An example process for training a machine learning model is described in further detail below with reference to FIG. 5.

Thus, the system can generate multiple types of models that output a likelihood based on measured errors that capture the difference between results computed using the aggregated data source and the event data source for training queries. The system can thus be used to select data sources for input queries based on measured data.

FIG. 4 depicts a visualization 400 of an example model for selecting a data source. The model visualized in FIG. 4 is an example of the grid model generated in step 360 of FIG. 3.

In the example of FIG. 4, the two characteristics are sampling ratio for the event data source and data loss percentage for the aggregated data source. For example, the x-axis represents the sampling ratio and the y-axis represents the data loss percentage. The labels 0-9 on the axes represent 0%-9%. The labels 10-19 on the axes represent 10%-100%.

The color legend 410 shows that the lighter the color in a particular box that corresponds to a combination of characteristics, the higher the likelihood that a result obtained using the event data source has a higher accuracy than a result obtained using the aggregated data source.

For example, for the box for the combination of 9 on the x-axis and 7 on the y-axis, the color indicates a likelihood of around 40%. Thus, if the model input includes 9% sampling ratio and 7% data loss percentage, the output of the model would be 40%. That is, the likelihood that a result obtained using the event data source is more accurate than a result obtained using the aggregated data source is 40%.

For example, as the sampling ratio approaches 100%, the boxes in the grid get lighter, as the likelihood that a result obtained using the event data source with a sampling rate close to 100% is close to 100%. That is, as the sampling rate approaches 100%, the result obtained is close to the unsampled result, and will have a high likelihood of being more accurate than the aggregated result.

As the sampling ratio approaches 100% and the data loss percentage approaches 100%, the boxes in the grid are the lightest, as it is more likely that a sampled result that is close to the unsampled result will be more accurate than an aggregated result where a high percentage of information is lost due to aggregation. For example, for the box for the combination of 19 on the x-axis and 19 on the y-axis, the color indicates a likelihood of 100%. Thus, if the model input includes 100% sampling ratio and 100% data loss percentage, the output of the model would be 100%. That is, the likelihood that a result obtained using the event data source is more accurate than a result obtained using the aggregated data source is 100%.

As the sampling ratio approaches 100% and the data loss percentage approaches 0%, the boxes in the grid get darker, as it is less likely that a sampled result that is close to the unsampled result will be more accurate than an aggregated result where less information is lost due to aggregation. For example, for the box for the combination of 19 on the x-axis and 1 on the y-axis, the color indicates a likelihood of around 80%. Thus, if the model input includes 100% sampling ratio and 1% data loss percentage, the output of the model would be 80%. That is, the likelihood that a result obtained using the event data source is more accurate than a result obtained using the aggregated data source is 80%.

FIG. 5 is a flow chart of an example process 500 for training a machine learning model for selecting a data source. A training system of the system 100 described above or another training system can perform the process 500 as part of step 370 of FIG. 3.

The system can obtain training examples (502). As described above with reference to FIG. 3, each training example can include a training model input and a ground-truth label that indicates which of the queried results had a lower error. For example, the system can use “0” to indicate that the sampled result had a lower error, and “1” to indicate that the aggregated result had a lower error.

The system can train the machine learning model on the training examples (504). For example, the system can train the machine learning model to output a likelihood that a result obtained using the event data source has a higher accuracy than a result obtained using the aggregated data source. As an example, the system can provide a training model input to the machine learning model to obtain a training likelihood. The system can compare the training likelihood to the ground-truth label for the training model input. For example, the system can determine a dissimilarity between the ground-truth label and the training likelihood using a log loss. The system can adjust the parameters of the machine learning model based on the comparison. For example, the system can determine adjusted model parameters for the machine learning model. Model parameters can include, for example, configuration variables, neural network weights, and coefficients of the machine learning model. By adjusting the model parameters, the machine learning model can be trained to more accurately predict the likelihood.

As an example, the machine learning model can be a binary classifier. In some examples, the machine learning model can include a linear/wide network, neural network, decision tree, gradient boosted decision tree, random forest model, and/or linear model.

In examples where the system includes more than two data sources to select from, the machine learning model can be a multiclass classifier. For example, the machine learning model can include a decision tree.

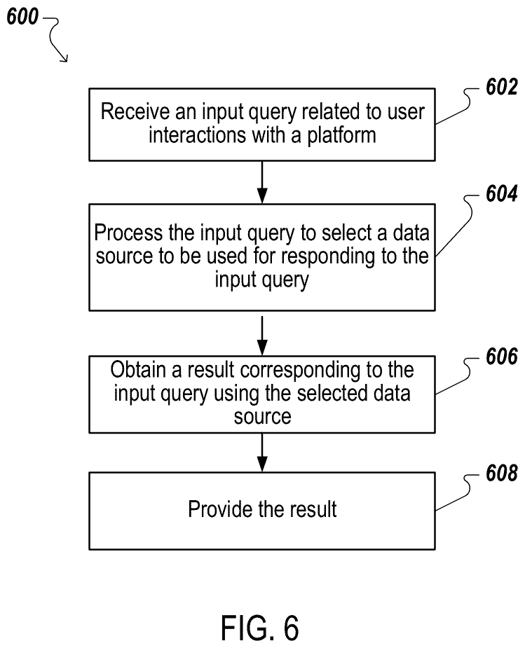

FIG. 6 is a flow chart of an example process 600 for obtaining a result for an input query using a selected data source. Operations of the process 600 can be performed, for example, by the system 100 of FIG. 1, or another data processing apparatus. The operations of the process 600 can also be implemented as instructions stored on a computer readable medium, which can be non-transitory. Execution of the instructions, by one or more data processing apparatus, causes the one or more data processing apparatus to perform operations of the process 600.

An input query related to user interactions with a platform is received (602). For example, the system can receive the input query from a user. The user interactions with the platform are user interactions for one or more users of the platform.

The input query can specify, for example, a type of interaction event for the user interactions, a time period for the user interactions, a geographic location for the user interactions, a count of the user interactions, and/or a frequency of the user interactions.

The platform includes multiple data sources for the platform that store information about the user interactions for the one or more users of the platform. This specification describes a system with an event data source and an aggregated data source for the platform, but the system can include a larger number of data sources for the platform. The system can also include data sources for other platforms.

Each of the data sources for the platform can include data related to user interactions with the platform for a window of time. For example, the event data source can include data related to user interactions with the platform over the last 30 days, the last 60 days, the last year, or another appropriate time period. The aggregated data source for the platform can include data related to user interactions with the platform over the last year.

The event data source includes, for each interaction event of multiple interaction events, one or more features and corresponding feature values for the respective interaction event. Some example features include geographic location for the interaction event, a time of the interaction event, a description of the interaction event, or an identifier for the interaction event.

The aggregated data source includes multiple aggregated results. Each aggregated result corresponds to a potential input query.

In some examples, at least one of the aggregated results can have been generated by aggregating corresponding feature values for two or more interaction events from the event data source over at least one feature, as described above with reference to FIG. 1.

The input query is processed to select a data source to be used for responding to the input query (604). For example, the system obtains an output from a model that includes a likelihood that a first result corresponding to the input query obtained using a first data source has a higher accuracy than each of one or more second results corresponding to the input query obtained using one or more second data sources. The selected data source is one of the multiple data sources for the platform.

As an example, the first data source can be the event data source, and one of the second data sources can be the aggregated data source. In some other examples, the first data source can be the aggregated data source, and one of the second data sources can be the event data source.

In some implementations, processing the input query includes determining whether a sampling ratio for the event data source meets a threshold sampling ratio. For example, the system can first determine whether a data loss percentage for the aggregated data source meets a threshold data loss percentage. In response to determining that the data loss percentage for the aggregated data source meets a threshold data loss percentage, the system determines whether the event data source is eligible to be used to compute a result corresponding to the input query. In response to determining that the event data source is eligible to be used to compute a result corresponding to the input query, the system determines whether a sampling ratio for the event data source meets a threshold sampling ratio.

In response to determining that the sampling ratio for the event data source meets the threshold sampling ratio, the system provides a model input to the model to obtain an output from the model. The model input includes at least two characteristics of the data sources.

For example, if the data sources include the event data source and the aggregated data source, the model input can include a sampling ratio for the event data source and a data loss percentage for the aggregated data source.

In some examples, the model is similar to the grid model described above with reference to FIG. 4. That is, the model includes, for each combination of characteristic values for two or more characteristics, a respective probability representing the likelihood that a first result corresponding to the input query obtained using the event data source has a higher accuracy than a second result corresponding to the input query obtained using the aggregated data source.

In some examples, the model is a trained machine learning model. In these examples, the model input can further include one or more features of the input query, one or more characteristics of the platform, and/or one or more features of a content item that is the subject of the input query. For example, one or more features of the input query can include a type of interaction event for the user interactions, a time period for the user interactions, a geographic location for the user interactions, a count of the user interactions, and/or a frequency of the user interactions.

The machine learning model can be trained to output a likelihood that a first result corresponding to the input query obtained using a first data source, e.g., the event data source, has a higher accuracy than each of one or more second results corresponding to the input query obtained using one or more second data sources, e.g., the aggregated data source.

For example, the machine learning model can be a trained classifier. In examples where the system includes one second data source, the machine learning model can be a binary classifier. The machine learning model can be trained on training data that includes multiple training examples. Each training example includes at least a training model input and a ground-truth label identifying one of the data sources as described above with reference to FIG. 3. The ground-truth label indicates that a first measured result obtained using the identified data source has a higher accuracy relative to one or more second measured results obtained using the other data sources.

The system selects the data source to be used for responding to the input query based on the output from the model. For example, the system obtains an output from a model that includes a likelihood that a first result corresponding to the input query obtained using the event data source has a higher accuracy than a second result corresponding to the input query obtained using the aggregated data source.

As an example, the system can determine whether the likelihood meets a threshold likelihood. For example, if the likelihood meets the threshold likelihood, the system can select the event data source to be used for responding to the input query.

As another example, the system can determine which of the data sources has a higher likelihood of having a higher accuracy. For example, if the likelihood is 52% that a result corresponding to the input query obtained using the event data source has a higher accuracy than a result corresponding to the input query obtained using the aggregated data source, then the likelihood that a result corresponding to the input query obtained using the aggregated data source has a higher accuracy than a result corresponding to the input query obtained using the event data source is 48%. The system can thus select the event data source because it has a higher likelihood of having a higher accuracy.

A result corresponding to the input query is obtained using the selected data source (606). For example, the system can query the selected data source using a database query. In some examples, the system can obtain the database query from the input query. For example, the system can process the input query and generate a database query in an appropriate format for querying the selected data source.

The result is provided (608). For example, the system can provide data representing the result to the user through a user interface.

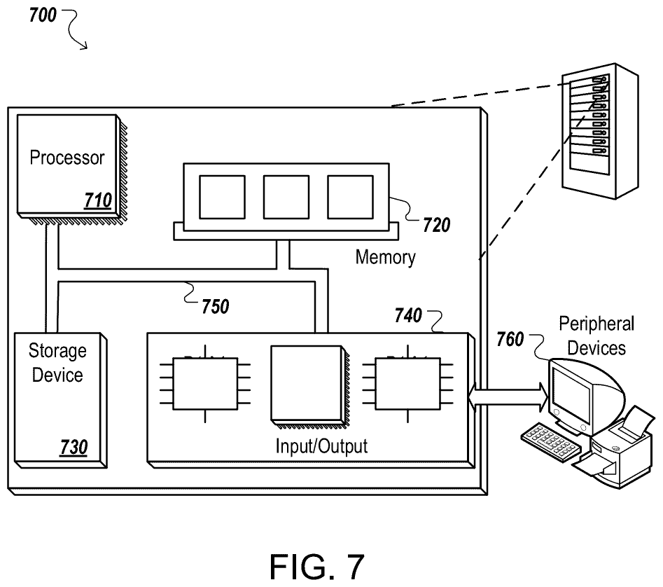

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 760. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In addition to the embodiments described above, the following embodiments are also innovative.

Embodiment 1 is a method comprising: receiving, from a user, an input query related to user interactions with a platform for one or more users of the platform; processing the input query to select a data source to be used for responding to the input query by obtaining an output from a model that comprises a likelihood that a first result corresponding to the input query obtained using a first data source has a higher accuracy than each of one or more second results corresponding to the input query obtained using one or more second data sources, wherein a plurality of data sources for the platform comprise the first data source and the one or more second data sources, and wherein the selected data source is one of the plurality of data sources for the platform, and wherein the plurality of data sources comprise at least an event data source and an aggregated data source; obtaining a result corresponding to the input query using the selected data source; and providing the result to the user.

Embodiment 2 is the method of embodiment 1, wherein the input query specifies one or more of: a type of interaction event for the user interactions, a time period for the user interactions, a geographic location for the user interactions, a count of the user interactions, or a frequency of the user interactions.

Embodiment 3 is the method of any of embodiments 1-2, wherein the event data source comprises, for each interaction event of a plurality of interaction events, one or more features and corresponding feature values for the respective interaction event.

Embodiment 4 is the method of embodiment 3, wherein the one or more features comprise any one or more of: a geographic location for the respective interaction event, a time of the respective interaction event, a description of the respective interaction event, or an identifier for the respective interaction event.

Embodiment 5 is the method of any of embodiments 1-4, wherein the aggregated data source comprises a plurality of aggregated results, wherein each of the aggregated results corresponds to a potential input query.

Embodiment 6 is the method of embodiment 5, wherein at least one of the aggregated results is generated by aggregating corresponding feature values for two or more interaction events over at least one feature.

Embodiment 7 is the method of any of embodiments 1-6, wherein processing the input query to select a data source to be used for responding to the input query comprises: determining whether a sampling ratio for the event data source meets a threshold sampling ratio; in response to determining that the sampling ratio for the event data source meets the threshold sampling ratio, providing a model input comprising at least two or more characteristics of the plurality of data sources to the model to obtain the output from the model; and selecting the data source to be used for responding to the input query based on the output from the model.

Embodiment 8 is the method of embodiment 7, wherein determining whether a sampling ratio for the event data source meets a threshold sampling ratio comprises: determining whether a data loss percentage for the aggregated data source meets a threshold data loss percentage; in response to determining that the data loss percentage for the aggregated data source meets a threshold data loss percentage, determining whether the event data source is eligible to be used to compute a result corresponding to the input query; and in response to determining that the event data source is eligible to be used to compute a result corresponding to the input query, determining whether a sampling ratio for the event data source meets a threshold sampling ratio.

Embodiment 9 is the method of any of embodiments 7-8, wherein selecting the data source to be used for responding to the input query based on the output from the model comprises: determining that the likelihood meets a threshold likelihood; and in response, selecting the first data source to be used for responding to the input query.

Embodiment 10 is the method of any of embodiments 1-9, wherein the first data source is the event data source and the one or more second data sources comprise the aggregated data source.

Embodiment 11 is the method of embodiment 10, wherein the two or more characteristics of the plurality of data sources comprise a sampling ratio for the event data source and a data loss percentage for the aggregated data source.

Embodiment 12 is the method of any of embodiments 10-11, wherein the model comprises, for each combination of characteristic values for the two or more characteristics, a respective probability representing the likelihood that a first result corresponding to the input query obtained using the event data source has a higher accuracy than a second result corresponding to the input query obtained using the aggregated data source.

Embodiment 13 is the method of any of embodiments 7-11, wherein the model input further comprises any one or more of: one or more features of the input query, or one or more characteristics of the platform.

Embodiment 14 is the method of embodiment 13, wherein the model has been trained to output a likelihood that a first result corresponding to the input query obtained using the first data source has a higher accuracy than each of one or more second results corresponding to the input query obtained using one or more second data sources.

Embodiment 15 is the method of embodiment 14, wherein the model is a trained classifier that has been trained on training data comprising a plurality of training examples, each comprising at least a model input, and a ground-truth label identifying one of the plurality of data sources, wherein a first measured result corresponding to the input query obtained using the identified data source has a higher accuracy relative to one or more second measured results.

Embodiment 16 is the method of any of embodiments 1-15, wherein obtaining a result corresponding to the input query using the selected data source comprises: obtaining a query from the input query; and querying the selected data source using the query.

Embodiment 17 is the method of any of embodiments 1-16, wherein the plurality of data sources for the platform comprise data related to user interactions with the platform for a window of time.

Embodiment 18 is a system comprising: one or more processors; and one or more storage devices storing instructions that, when executed by the one or more processors, cause the one or more processor to carry out operations of any of embodiments 1-17.

Embodiment 19 is a computer readable storage medium carrying instructions that, when executed by one or more processors, cause the one or more processors to carry out operations of any of embodiments 1-17.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
receiving, from a user, an input query related to user interactions with a platform for one or more users of the platform;
processing the input query to select a data source of a plurality of data sources to be used for responding to the input query, comprising:
providing a model input comprising at least two or more characteristics of the plurality of data sources to a model to obtain an output from the model, wherein the output comprises a likelihood that a first result corresponding to the input query obtained using a first data source has a higher accuracy than each of one or more second results corresponding to the input query obtained using one or more second data sources, wherein the plurality of data sources for the platform comprise the first data source and the one or more second data sources, and wherein the plurality of data sources comprise at least an event data source and an aggregated data source; and
selecting the data source to be used for responding to the input query based on the output from the model;
obtaining, using the selected data source, a result that describes user interactions with the platform and that is responsive to the input query; and
providing the result to the user.

2. The method of claim 1, wherein the input query specifies one or more of: a type of interaction event for the user interactions, a time period for the user interactions, a geographic location for the user interactions, a count of the user interactions, or a frequency of the user interactions.

3. The method of claim 1, wherein the event data source comprises, for each interaction event of a plurality of interaction events, one or more features and corresponding feature values for the respective interaction event.

4. The method of claim 3, wherein the one or more features comprise any one or more of: a geographic location for the respective interaction event, a time of the respective interaction event, a description of the respective interaction event, or an identifier for the respective interaction event.

5. The method of claim 1, wherein the aggregated data source comprises a plurality of aggregated results, wherein each of the aggregated results corresponds to a potential input query.

6. The method of claim 5, wherein at least one of the aggregated results is generated by aggregating corresponding feature values for two or more interaction events over at least one feature.

7. The method of claim 1, wherein processing the input query to select a data source of a plurality of data sources to be used for responding to the input query comprises:
determining whether a sampling ratio for the event data source meets a threshold sampling ratio; and
in response to determining that the sampling ratio for the event data source meets the threshold sampling ratio, providing the model input to the model to obtain the output from the model.

8. The method of claim 7, wherein determining whether a sampling ratio for the event data source meets a threshold sampling ratio comprises:
determining whether a data loss percentage for the aggregated data source meets a threshold data loss percentage;
in response to determining that the data loss percentage for the aggregated data source meets a threshold data loss percentage, determining whether the event data source is eligible to be used to compute a result corresponding to the input query; and
in response to determining that the event data source is eligible to be used to compute a result corresponding to the input query, determining whether a sampling ratio for the event data source meets a threshold sampling ratio.

9. The method of claim 1, wherein selecting the data source to be used for responding to the input query based on the output from the model comprises:
determining that the likelihood meets a threshold likelihood; and
in response, selecting the first data source to be used for responding to the input query.

10. The method of claim 1, wherein the first data source is the event data source and the one or more second data sources comprise the aggregated data source.

11. The method of claim 10, wherein the two or more characteristics of the plurality of data sources comprise a sampling ratio for the event data source and a data loss percentage for the aggregated data source.

12. The method of claim 10, wherein the model comprises, for each combination of characteristic values for the two or more characteristics, a respective probability representing the likelihood that a first result corresponding to the input query obtained using the event data source has a higher accuracy than a second result corresponding to the input query obtained using the aggregated data source.

13. The method of claim 1, wherein the model input further comprises any one or more of: one or more features of the input query, or one or more characteristics of the platform.

14. The method of claim 13, wherein the model has been trained to output a likelihood that a first result corresponding to the input query obtained using the first data source has a higher accuracy than each of one or more second results corresponding to the input query obtained using one or more second data sources.

15. The method of claim 14, wherein the model is a trained classifier that has been trained on training data comprising a plurality of training examples, each comprising at least a model input, and a ground-truth label identifying one of the plurality of data sources, wherein a first measured result corresponding to the input query obtained using the identified data source has a higher accuracy relative to one or more second measured results.

16. The method of claim 1, wherein obtaining a result corresponding to the input query using the selected data source comprises:
obtaining a query from the input query; and
querying the selected data source using the query.

17. The method of claim 1, wherein the plurality of data sources for the platform comprise data related to user interactions with the platform for a window of time.

18. A system comprising:
one or more processors; and
one or more storage devices storing instructions that, when executed by the one or more processors, cause the one or more processors to carry out operations comprising:
receiving, from a user, an input query related to user interactions with a platform for one or more users of the platform;
processing the input query to select a data source of a plurality of data sources to be used for responding to the input query, comprising:
providing a model input comprising at least two or more characteristics of the plurality of data sources to a model to obtain an output from the model, wherein the output comprises a likelihood that a first result corresponding to the input query obtained using a first data source has a higher accuracy than each of one or more second results corresponding to the input query obtained using one or more second data sources, wherein the plurality of data sources for the platform comprise the first data source and the one or more second data sources, and wherein the plurality of data sources comprise at least an event data source and an aggregated data source; and
selecting the data source to be used for responding to the input query based on the output from the model;
obtaining, using the selected data source, a result that describes user interactions with the platform and that is responsive to the input query; and
providing the result to the user.

19. The system of claim 18, wherein processing the input query to select a data source of a plurality of data sources to be used for responding to the input query comprises:
determining whether a sampling ratio for the event data source meets a threshold sampling ratio; and
in response to determining that the sampling ratio for the event data source meets the threshold sampling ratio, providing the model input to the model to obtain the output from the model.

20. A computer readable storage medium carrying instructions that, when executed by one or more processors, cause the one or more processors to carry out operations comprising:
receiving, from a user, an input query related to user interactions with a platform for one or more users of the platform;
processing the input query to select a data source of a plurality of data sources to be used for responding to the input query, comprising:
providing a model input comprising at least two or more characteristics of the plurality of data sources to a model to obtain an output from the model. wherein the output comprises a likelihood that a first result corresponding to the input query obtained using a first data source has a higher accuracy than each of one or more second results corresponding to the input query obtained using one or more second data sources, wherein the plurality of data sources for the platform comprise the first data source and the one or more second data sources, and wherein the plurality of data sources comprise at least an event data source and an aggregated data source; and
selecting the data source to be used for responding to the input query based on the output from the model;
obtaining, using the selected data source, a result that describes user interactions with the platform and that is responsive to the input query; and
providing the result to the user.
